(19) United States
(12) Patent Application Publication
(10) Pub. No.: US 2010/0315257 A1
(43) Pub. Date: Dec. 16, 2010

(54) PORTABLE DATA MEDIUM AND METHOD FOR TRANSFERRING CONFIGURATION DATA FROM AN EXTERNAL COMPUTER TO A SENSOR

(75) Inventors: Dennis Trebbels, Neustadt an der Weinstrasse (DE); Heiko Hoebel, Worms (DE); Tobias Bergtholdt, Mannheim (DE)

Correspondence Address: HOFFMAN WARNICK LLC, 75 STATE STREET, 14TH FLOOR, ALBANY, NY, 12207, US

(73) Assignee: PEPPERL + FUCHS GMBH, Mannheim (DE)

(21) Appl. No.: 12/744,155

(22) PCT Filed: Nov. 20, 2008
(86) PCT No.: PCT/EP08/09843

§ 371 Date: May 21, 2010

(30) Foreign Application Priority Data
Nov. 21, 2007 (EP) 07022629.5

(51) Int. Cl. G06F 12/02; G09F 9/33

(52) U.S. Cl. 340/815.45; 711/104; 711/E12.007

(57) ABSTRACT

The present invention is directed to a portable data medium and method for transferring configuration data from an external computer to a sensor. The portable data medium includes: a first connector for connecting the data medium to an external computer, a read-write memory for buffering the configuration data, which memory cooperates with the first connector, wherein the first connector transfers the configuration data from the external computer to the read-write memory; wherein in the read-write memory there is stored a configuring software program, which can be uploaded into an RAM of the external computer when the data medium is connected to the external computer; the configuring software program permits compilation of the configuration data for the sensor at least one of automatically and interactively by a user; for the purpose of connecting the data medium to the sensor, a second connector is present which cooperates with the read-write memory and transfers the configuration data from the read-write memory to a memory of the sensor when the data medium is connected to the sensor; and an independent power supply is present for supplying the data medium with electrical energy.

In a first aspect, the present invention relates to a portable data medium for transferring configuration data, especially firmware, from an external computer to a sensor as defined in the generic clause of claim 1.

In a second aspect, the invention relates to a method for transferring configuration data from an external computer to a sensor.

A generic portable data medium, e.g. a conventional USB stick, comprises a first connecting means for connecting the data medium to the external computer and a read-write memory for buffering the configuration data, which memory interacts with the first connecting means. The first connecting means is adapted to transfer the configuration data from the external computer to the read-write memory.

In addition to simple detection of a measurand, sensors nowadays have comprehensive and variably adjustable functionalities. For this reason the sensors are typically equipped with a control/evaluation unit, in which the program sequences are stored. The special software installed for the terminal devices having a size of up to some megabytes is also known as firmware. Such a control/evaluation unit can be formed, for example, by a microcontroller, this being a fully fledged computer having a CPU, a memory, and appropriate interfaces. For the provision of the desired procedures and functions, the appropriate program codes are transferred to this microcontroller. In addition, a multitude of parameter settings are usually made. For example, a sensor might be set to determine the output voltage interval required to represent a measured physical variable. Time intervals between measurements can be defined, and it is possible to define whether mean values, or minima or maxima are to be detected and outputted. Finally, in firmware or in corresponding parameter or configuration settings, details concerning the communication between the sensor and a peripheral unit are defined.

Basically, the peripheral unit can be a relay, some other switchgear or control mechanism, a power supply unit, or an evaluation unit or bus system. In most instances the sensor is connected, in operating mode, to a programmable logic control unit as the peripheral unit.

To accomplish the transfer of program data and configuration data, especially the firmware, the sensors have hitherto had to be connected to a computer by means of a serial interface or a network connection. In such a case an interface converter is required, which either takes electrical power from the external computer, i.e. the PC, or requires its own power supply unit. Usually RS-232 or RS-485 interfaces are employed for this purpose. However, the data transfer is comparatively slow, and an update of large software volumes is thus cumbersome. The interface converter is also known as a downloading device or programming device.

An alternative procedure transfers the required data by means of intermittent short-circuiting. To this end, the sensor is normally disconnected from the peripheral unit to which it is connected during the normal measuring mode of operation and the programming device is connected to the vacant plug-type connector. By means of defined short circuits between the individual contacts of the plug-type connector, the required configuration data, in particular a new firmware version, are then transferred to the sensor. This also requires a separate programming device and this procedure is likewise comparatively slow.

In the case of sensors already set up at the required site of action it is accordingly laborious to execute parameter changes or to upload a new firmware version. In particular, there has always been the need for an external computer on which either a graphical user interface or a test program must be installed.

A proximity switch that allows for the transfer of both data and electrical energy via an electrical connection is described in DE 41 23 828 C2. US 2005/0083741 A1 and U.S. Pat. No. 7,165,109 B2 refer to the functionality of USB components. U.S. Pat. No. 7,165,109 B2 describes a procedure in which a component connected to a computer's USB port prompts the computer to download suitable driver software for the component via the Internet. U.S. Pat. No. 5,173,855 describes a portable programming device for the programming of irrigation sensors. U.S. Pat. No. 5,590,373 discloses a device for the transfer of software to a mobile communication device.

It is an object of the invention to provide a device and method which simplify the transfer of configuration data from an external computer to a sensor.

In a first aspect, the invention achieves this object by means of the portable data medium having the features of claim 1.

In a second aspect, the object is achieved by means of the method having the features of claim 15.

Preferred embodiments of the portable data medium of the present invention and advantageous variants of the method of the present invention are the subject matter of the dependent claims and are also described in the description, particularly with reference to the FIGURE.

According to the invention, the portable data medium of the aforementioned type is developed in that a configuration software program is stored in the read-write memory, which can be uploaded into the RAM of an external computer when the data medium is connected to the latter; that the configuration software program is adapted to cause at least automatic or user-interactive compilation of the sensor's configuration data; that a second connecting means for connecting the data medium to the sensor is available which interacts with the read-write memory and which is adapted to transfer the configuration data from the read-write memory to the sensor's memory when the data medium is connected to the sensor; and that an independent power supply is available for supplying power to the data medium.

In the method of the invention, a portable data medium is connected to an external computer by means of a first connecting means, a configuration software program stored in a read-write memory of the data medium is subsequently uploaded into the RAM of the computer, and then the configuration data are automatically compiled or interactively compiled by the user and stored in the read-write memory of the data medium with the aid of the configuration software program. The data medium is then connected to the sensor by means of a second connecting means and the configuration data are transferred from the data medium to the sensor via said second connecting means.

A central idea of the invention may be considered to reside in the fact that the transfer of the configuration data is accomplished without the sensor being connected to the external computer by means of a programming device, but instead a portable data medium is used.

In particular, the portable data medium should be a hand-portable data medium, i.e. a device which can be easily transported to the respective site of action by the user.

Another central idea of the invention may be considered to be the fact that the portable data medium is equipped with a special second connecting means such that the data medium can be connected to the sensor by means of the second connecting means and the required configuration data can be transferred from the data medium's read-write memory to the sensor.

A further basic idea of the invention relating to the design of the data medium such that the required software for compilation of the configuration data for the sensor is stored in the data medium itself, is based on the realization that currently available microcontrollers or memory modules have sufficiently large memory areas to allow for storage of a configuration software program for the sensor.

An essential advantage of the invention may be considered to reside in the fact that especially in complex industrial surroundings firmware or parameter updates can be carried out extremely quickly since it is substantially only necessary to connect the portable data medium to the sensor.

Another important advantage of the invention is that it is no longer necessary to provide CDs, DVDs or similar data media on which the required software for parameterization or configuration is stored. Finally the necessity for the user to install software on the external computer no longer exists when implementing the present invention. Moreover, it is advantageous that the invention makes it possible to use conventional hardware and platform-independent software.

Accordingly, downloading a device firmware is considerably simplified by the invention.

The sensors used can be any type of sensors employed in automation technology for the detection of a physical measurand or for the detection of articles or objects. The present invention can be used to particular advantage in the industrial sector, e.g. as inductive, capacitive, or optical sensors, or temperature sensors or pressure sensors. Another application can be identification sensors, e.g. RFID reading heads, and the invention can also be used to transfer the required configuration data to a control/evaluation unit for a plurality of such RFID reading heads or to the reading heads themselves.

In the present description the term “configuration” should be taken to mean any alteration or adjustment of a sensor by means of software. This comprises in particular any transfer of program code or binary code to the sensor and the loading of firmware and the modification of, and/or the addition of, parameters. The term “configuration data” should be interpreted in a corresponding manner so as to mean any software-related data that are transferred to the sensor or to the data medium.

The configuring mode always involves a configuring procedure which can theoretically be performed during the measuring operation. Accordingly, the configuring mode and the operating mode can overlap in time, i.e. they can be executed simultaneously.

In the present description a connecting means should be understood to mean especially those components required to establish an interface connection, i.e. a data link, between the data medium and the sensor or between the data medium and the control/evaluation unit. Furthermore, this interface connection can be implemented to transmit electrical power for supplying the portable data medium. In principle this can be carried out wirelessly, e.g. per radio transmission. Theoretically, combinations are possible, so that for example the energy can be transmitted per cable and the data per radio transmission. Functional embodiments of the data medium of the present invention, however, involve the use of suitable plug-type connections, which can transfer both data and electrical energy.

For this purpose the first connecting means and the second connecting means in each case comprise hardware, especially plug-type connectors, as well as software.

Theoretically, the data transfer between the portable data medium and the sensor can be effected on the basis of any desired protocol. Interfaces and protocols with which the sensor and the control/evaluation unit already work, are especially preferred. The data transfer between the data medium and the sensor or the control/evaluation unit is advantageously carried out via a serial interface, especially an RS-232 or an RS-485 interface.

Preferably, a USB protocol may be used. The software for the first connecting means can then be adapted to provide, especially automatically, USB slave functionality when the data medium is connected to the external computer. The software for the second connecting means can correspondingly be adapted to provide, especially automatically, USB host functionality when the data medium is connected to the sensor. It will then be possible to make use of widespread standards. The data medium will then be recognized and treated as, for example, a mass storage device by the external computer.

The data medium acts as a USB slave and the external computer acts as a USB host during data transfer between the data medium and the external computer. The data medium accordingly acts as a USB host and the sensor as a USB slave during data transfer between the data medium and the sensor.

In an advantageous embodiment, the second connecting means of the data medium thus has a plug-type connection which mates with a plug-type connector on the sensor or the control/evaluation unit.

In automation technology round plug-type connectors having a sealing effect are very preferably used as plug-type connectors for sensors. They can be, say, 4 or 5 pin connectors, in particular V1 or V3 connectors.

The sensors or the control/evaluation unit can, as such, remain completely unmodified, since the conventional plug-type connections can be used.

It is also advantageous to implement standard interfaces on the computer for data transfer between the external computer and the portable data medium. Therefore the data transfer between the data medium of the present invention and the external computer is very preferably carried out via a USB or Firewire interface. In this connection, use may be made of variants and developments of USB interfaces. Accordingly, the first connecting means of the data medium advantageously incorporates a USB connector.

Theoretically, the first and second connecting means can be separate physical units. In a particularly preferred embodiment of the data medium of the present invention, however, the first and second connecting means are formed by one and the same connecting unit, in particular by one and the same plug-type connector. This is preferably a USB connector.

In a main aspect, the invention relates to the transfer of configuration data from the data medium of the invention to a sensor. Theoretically, it is possible for the data medium to be connected to a control/evaluation unit and for the configuration data to be transferred to the control/evaluation unit itself or to sensors connected to said control/evaluation unit.

In order that the data medium can communicate with a sensor in a suitable manner, it is furthermore advantageous when an electronic system is present which can identify an interface on the sensor when the data medium is connected to the sensor. Advantageously there are provided suitable means to enable the data medium to choose between a plurality of interface protocols, e.g. RS-232, RS-485 and USB.

In another preferred variant, the entire data medium is designed as an interface adapter.

To avoid conflicts, between, say, an external computer and a sensor when both are connected to a data medium working as interface converter, and to avoid damage to the external computer or the sensor, it is advantageous when the portable data medium additionally includes an electronic system which is capable of detecting whether the data medium is connected to a computer and/or to a sensor or to a control/evaluation unit. When checking which device or devices are connected to the data medium, this electronic system can recognize the voltage levels present at the relevant connecting means and additionally or alternatively detect any data signals present at such points.

The protection from damage to the sensor connected to the data medium, to a control/evaluation unit or to an external computer can be further improved by galvanically isolating the first connecting means and the second connecting means particularly by the use of optocouplers.

In another preferred variant, the portable data medium comprises optical display means, in particular light emitting diodes, to display the function states of the data medium. There can be, say, a yellow LED for indicating active downloading, e.g. by blinking. Furthermore, a two-in-one LED can emit green light when a suitable supply voltage is applied or it can emit red light when an error occurs.

A data download can be a very easy matter for the user when a transfer of the configuration data takes place automatically from the external computer to the data medium after the data medium has been connected to the external computer and/or the transfer of the configuration data is automatically carried out from the data medium to a sensor once the data medium has been connected to the sensor or to the control/evaluation unit.

The data transfer from the computer to the data medium or from the data medium to the sensor can in each case also be started after simple confirmation by the user, i.e. with minimal user interaction, for example by a single keystroke.

Furthermore, tests on the function, plausibility, and/or consistency of operation of the sensor or the control/evaluation unit can be performed following the transfer of the configuration data to the sensor or control/evaluation unit, in order to ensure that the control/evaluation unit or the sensor is fully functional following the data transfer.

Moreover, it is particularly convenient for the user when the configuration software program is started on the external computer automatically or after user confirmation following connection of the data medium to the external computer.

In case settings in the external computer do not permit completely automatic starting of the configuration software program, provision may preferably be made for, at all events, only minimal user interaction, e.g. simple confirmation by pressing the ENTER key, to be required.

The configuration software program can be stored on the data medium of the invention basically as an executable code. To achieve greater independence from the external computer actually used, the configuration software program can very preferably be executable on any platform. For example the configuration software program can also be stored in the form of an interpretable code.

Following connection of the data medium of the invention to the external computer, provision may be made for the external computer to be prompted to establish a network connection and thereafter to check whether the program files on the data medium comply with the latest versions. The latest version of a user manual or of the program files can then be downloaded to the data medium.

To achieve the aforementioned functionality, the data medium preferably comprises one or more microcontrollers, FPGAs, CPLDs, GALs or other programmable logic components, if necessary with the required memory modules.

Additional memory modules can be used, if the storage capacity of the microcontroller employed should not suffice.

Advantageously, a boot loader can be present or stored on the data medium to make subsequent programming of the microcontroller possible.

It is a particular advantage of the invention that virtually any type of computer can be used as the external computer. For example, in the manufacturing process, PCs can be used and in this connection customer-specific parameterizations and function tests can be performed. Laptops, handhelds or palmtops are preferably used when a new configuration or calibration should be necessary at the site of action. Theoretically, even a mobile phone could be used for this purpose.

Moreover the memory of the data medium preferably has a read-only area, which can be used, for example, to store a user manual, which can be opened on the external computer, once this has been connected. Such a user manual can be updated or supplemented, in which case the external computer can download up-to-date versions from the Internet and subsequently transfer them to the data medium.

In another preferred variant of the data medium and method of the invention the first and/or second connecting means are adapted to transmit configuration data via two leads of a data line differentially between the data medium and the computer and/or between the data medium and the sensor. In this way it is possible to achieve higher interference resistance and thus greater speed.

Existing conventional protocols are preferably used. The data can be exchanged between the data medium and the external computer or the sensor at a bandwidth of more than 1 Mbit/s. This has the added advantage that no further development work is required.

Further advantages and features of the present invention are described below with reference to the attached drawing, in which:

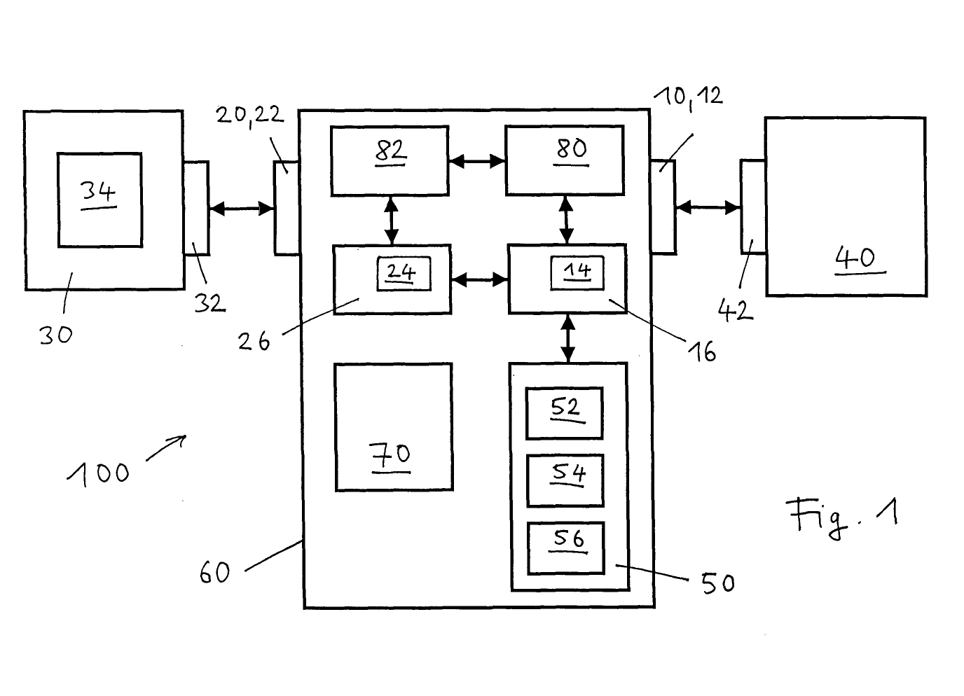

FIG. 1 is a diagrammatic illustration of an exemplary embodiment of a portable data medium of the invention.

The data medium 100 of the invention shown in FIG. 1 comprises a first connecting means 10, a second connecting means 20, a read-write memory 50 and an independent power supply 70 as essential components.

The first connecting means 10 includes a plug-type connector 12, e.g. a USB plug, and software program 14 stored in a microcontroller 16. Data can be exchanged between the data medium 100 of the invention and a USB plug-type connector 42 of an external computer 40 through a data line via a USB protocol. The second connecting means comprises a plug-type connector 22 and a software program 24 stored, in the example shown, in an additional microcontroller 26.

The plug-type connector 22 is a round plug-type connector having a sealing effect and mates with the corresponding round plug-type connector 32 of a sensor 30, to which the data medium 100 can be connected to effect data transfer according to the present invention.

The independent power supply 70, which can, in particular, be an accumulator or batteries, allows for independent operation of the data medium 100 of the invention, especially at the site of action of the sensor 30 to be newly configured. In particular, it is possible to transfer data to sensors having only one plug-type connector and accordingly have to be disconnected from their normal power supply for the duration of the data transfer. Therefore such sensors can be supplied with electrical energy by the data medium 100 of the invention for the duration of the data transfer.

Theoretically, it is possible to use appliances capable of converting the warmth of the hands or shaking movements to electrical energy as independent power supply devices.

According to the invention, a configuration software program 56, preferably in a substantially platform-independent programming language, is stored in the read-write memory 50. The configuration software program can be stored, e.g., as an interpretable program code. Preferably the configuration software program 56 includes a graphical user interface and is therefore easy to use by the user.

Furthermore firmware 52 for the sensor 30 and a parameter file 54 are stored in the read-write memory 50.

The data medium 100 of the invention operates as follows. When the data medium 100 is connected to the external computer 40, the configuration software program 56 is started on the computer 40, either automatically or following confirmation by a user. The user can then, by way of the graphical user interface, compile the configuration data to be finally transferred to the sensor 30.

Such data can be program data, for example the latest firmware, and parameter settings. The data medium of the invention is used as a USB slave for this data transfer, this functionality being achieved by the software 14 in the microcontroller in cooperation with the plug-type connector 12, and the external computer 40 acts as a USB host.

Thereafter the data medium 100 is disconnected from the computer 40 and taken to the sensor's site of action. The sensor 30 is then disconnected from its normal operating connection, e.g. a peripheral unit, and connected to the data medium 100 of the invention. The configuration data, which were either compiled by the user or automatically uploaded to the data medium 100 of the invention, are then transferred to a memory 34 in the sensor 30. This is again preferably carried out automatically without the need for further user activity apart from connecting the data medium 100 to the plug-type connector 32 of the sensor 30.

During the data transfer from the data medium 100 of the invention, the sensor 30 preferably acts as a USB slave and the data medium 100 of the invention now acts as a USB host. This USB host functionality is achieved by the microcontroller 26 and the software 24 in cooperation with the plug-type connector 22.

An electronic system 80 is present to check where the data medium 100 of the invention is connected. For example, it can analyze levels and/or data signals applied to the contacts of the plug-type connectors 12, 22.

The data medium 100 is accommodated in a housing 60, of a size substantially determined by the independent power supply 70.

The functionality of the data medium 100 is also enhanced by another electronic system 82, which can detect the type of interface, e.g. USB or RS-232, to which the plug-type connector 22 is connected. The electronic system 82 cooperates with the microcontroller 26, which can adapt itself to the relevant interface detected.

Sensors having communication interfaces are known from the prior art, which interfaces are used for programming such sensors by means of wired programming devices, These programming devices act as physical level converters and as protocol converters. However, there is always the need for a PC on which a program, for example one having a graphical user interface, or a test program, is running. These known programming devices cannot be used without a PC.

The present invention provides a novel portable data medium, which can also be considered as an independent, autarkic or stand-alone programming device. This data medium of the invention comprises an enlarged memory, in which several programs, firmware, files, and parameters can be stored. The data medium or the programming device still comprises two interfaces, more particularly two USB interfaces. One of the interfaces serves to connect the data medium to the sensor and the other interface makes it possible to connect the data medium to a PC. The interfaces are herein also referred to as connecting means. Unlike a PC, the programming device can also act as a normal USB slave. Hence it is possible for the user to himself configure the programming device, i.e. the data medium, from a PC and to transfer, say, a new firmware or files to, and store them in, said programming device. Following configuration of the programming device, i.e. following compilation of the configuration data for the sensor, the data medium can act as an independent device and behave as a USB host in relation to a connected sensor. The sensor typically operates as a USB slave. Theoretically the host/slave relationship can be reversed. On the whole, it is possible to configure a plurality of sensors without the need for a PC in this manner and/or to alter or supplement a configuration. This is particularly advantageous in the case of sensors that have already been installed.

Basically, the data medium described herein also allows for implementation of already existing interfaces. The variant in which communication takes place via both the first and the second connecting means via a USB protocol is a particularly preferred embodiment.

The programming device comprises in its read-write memory 50 a program, e.g. a Java file, which can be executed platform-independently on a PC 40. This program presents, e.g., a graphical user interface and is executable on any PC once the programming device has been connected to a PC via a USB connection.

The settings then made are stored, e.g., in a file and the programming device can now be disconnected from the PC 40. When a sensor 30 is subsequently connected to the programming device, the stored settings can be transferred thereto. Due to the aforementioned electronic system 82, the data medium of the invention can in addition adapt itself to different interfaces of the sensors. It is no longer necessary for a PC to transfer data to the sensor 30.

A further advantage of the invention is that the actual programming device, i.e. the data medium 100, can be kept comparatively small and lightweight and the sensors can thus be configured in an installed state, as there is no longer any need for a PC or a laptop.

Theoretically, the functionality described herein could be realized in one single sensor. However, the graphical operating program would then have to be stored in each individual sensor and more storage capacity would thus be required.

1-25. (canceled)

26. A portable data medium for transferring configuration data comprising a first connecting means for connecting the data medium to an external computer, a read-write memory for buffering the configuration data, which memory cooperates with the first connecting means, wherein the first connecting means is adapted to transfer the configuration data from the external computer to the read-write memory;
wherein
in the read-write memory there is stored a configuring software program, which can be uploaded into an RAM of the external computer when the data medium is connected to the external computer;
the configuring software program is adapted to permit compilation of the configuration data for the sensor at least one of automatically and interactively by a user;
for the purpose of connecting the data medium to the sensor, a second connecting means is present which cooperates with the read-write memory and is adapted to transfer the configuration data from the read-write memory to a memory of the sensor when the data medium is connected to the sensor; and
an independent power supply is present for supplying the data medium with electrical energy.

27. The data medium as defined in claim 26,
wherein
the first connecting means and the second connecting means each comprise hardware means and software.

28. The data medium as defined in claim 26,
wherein
the first connecting means and the second connecting means each comprise plug-type connectors and software.

29. The data medium as defined in claim 27,
wherein
the software for the first connecting means is adapted to impart USB slave functionality thereto when the data medium is connected to the external computer.

30. The data medium as defined in claim 27,
wherein
the software for the first connecting means is adapted to automatically impart USB slave functionality thereto when the data medium is connected to the external computer.

31. The data medium as defined in claim 27,
wherein
the software for the second connecting means is adapted to impart USB host functionality thereto when the data medium is connected to the sensor.

32. The data medium as defined in claim 27,
wherein
the software for the second connecting means is adapted to automatically impart USB host functionality thereto when the data medium is connected to the sensor.

33. The data medium as defined in claim 26,
wherein
the first connecting means comprises a USB plug-type connector.

34. The data medium as defined in claim 26,
wherein
the second connecting means comprises a round plug-type connector having a sealing effect.

35. The data medium as defined in claim 26,
wherein
the second connecting means comprises a round plug-type connector having a sealing effect and embodying 4 or 5 pins.

36. The data medium as defined in claim 26,
wherein
an electronic system is present for detecting whether the data medium is connected to the computer and/or to the sensor.

37. The sensor as defined in claim 36,
wherein
the electronic system analyzes a supply voltage applied to at least one of the following: a contact of the first connecting means and a contact of the second connecting means.

38. The sensor as defined in claim 36,
wherein
the electronic system analyzes a data signal present at least one of the following: a contact of the first connecting means and a contact of the second connecting means.

39. The data medium as defined in claim 26,
wherein
an electronic system is present for detecting a computer interface on the sensor when the data medium is connected to the sensor.

40. The data medium as defined in claim 26,
wherein
optical indicators are present for indicating functional states of the data medium.

41. The data medium as defined in claim 26,
wherein
light-emitting diodes are present for indicating functional states of the data medium.

42. The data medium as defined in claim 26, which is designed as an interface adapter.

43. The data medium as defined in claim 26,
wherein
the first connecting means and the second connecting means are galvanically isolated.

44. The data medium as defined in claim 26,
further comprising:
a read-only memory area.

45. The data medium as defined in claim 26,
wherein the external computer is connected to the sensor;
wherein the data medium is connected to the external computer via the first connecting means;
wherein the configuring software program stored in the read-write memory of the data medium is then uploaded into the RAM of the computer;
wherein configuration data are then compiled using the configuring software program, at least one of automatically and interactively, by a user, and stored in the read-write memory of the data medium;
wherein the data medium is connected to the sensor via a second connecting means, and
wherein the configuration data are transferred from the data medium via the second connecting means to the sensor.

46. A method for transferring configuration data from an external computer to a sensor, in which a portable data medium is connected to the external computer via a first connecting means,
wherein a configuring software program stored in a read-write memory of the data medium is then uploaded into an RAM of the computer;
wherein configuration data are then compiled with the aid of the configuring software program, at least one of automatically and interactively, by a user, and stored in the read-write memory of the data medium;
wherein the data medium is connected to the sensor via a second connecting means; and
wherein the configuration data are transferred from the data medium via the second connecting means to the sensor.

47. The method as defined in claim 46, which is configured to transfer firmware from an external computer to the sensor.

48. The method as defined in claim 46,
wherein
the data transfer between the data medium and the external computer is effected via a USB or Firewire interface.

49. The method as defined in claim 46,
wherein
the data transfer between the data medium and the sensor is effected via a USB or Firewire interface.

50. The method as defined in claim 46,
wherein
the data transfer between the data medium and the external computer and between the data medium and the sensor is effected via a USB or Firewire interface.

51. The method as defined in claim 46,
wherein
the data transfer between the data medium and the sensor is effected via a serial interface.

52. The method as defined in claim 46,
wherein
the data transfer between the data medium and the sensor is effected via an RS-232 interface.

53. The method as defined in claim 46,
wherein
during data transfer between the data medium and the external computer, the data medium acts as a USB slave and the external computer acts as a USB host.

54. The method as defined in claim 46,
wherein
during the data transfer between the data medium and the sensor, the data medium acts as a USB host and the sensor acts as a USB slave.

55. The method as defined in claim 46,
wherein
during the transfer of the configuration data, the sensor is supplied with electrical energy by an independent power supply pertaining to the data medium.

56. The method as defined in claim 46,
wherein
after the data medium has been connected to the external computer, the configuring software program is automatically started on the external computer.

57. The method as defined in claim 46,
wherein
after the data medium has been connected to the external computer, the configuring software program is started on the external computer following confirmation by a user.

58. The method as defined in claim 46,
wherein
the transfer of the configuration data from the external computer to the data medium is carried out automatically after the data medium has been connected to the external computer.

59. The method as defined in claim 46,
wherein
the transfer of the configuration data from the data medium to a sensor is carried out automatically when the data medium is connected to the sensor.

60. The method as defined in claim 46,
wherein
the transfer of the configuration data from the external computer to the data medium is carried out automatically after the data medium has been connected to the external computer and the transfer of the configuration data from the data medium to a sensor is carried out automatically when the data medium is connected to the sensor.

61. The method as defined in claim 46,
wherein
the configuring software program is stored in the memory of the data medium as an executable or interpretable program.

62. The method as defined in claim 46,
wherein
the configuring software program prompts the external computer to establish a network connection to a remote-host and to check whether at least one of new program versions for the configuring software program and sensor firmware are available; and
any new program versions are downloaded from the remote-host and transferred to the read-write memory of the data medium.

63. The method as defined in claim 46,
wherein
at least one of prior to and following the transfer of the configuration data to the sensor, the sensor is subjected to tests on at least one of function and consistency.
